(19) United States
(12) Patent Application Publication
(10) Pub. No.: US 2015/0102682 A1
(43) Pub. Date: Apr. 16, 2015

(54) SOFT POWER WIRELESS TRANSMISSION INDUCTION PLATE

(71) Applicant: COREMATE TECHNICAL CO., LTD., Taoyuan County (TW)

(72) Inventor: Robert WANG, TAOYUAN COUNTY (TW)

(73) Assignee: COREMATE TECHNICAL CO., LTD., TAOYUAN COUNTY (TW)

(21) Appl. No.: 14/055,285

(22) Filed: Oct. 16, 2013

(51) Int. Cl. H01F 38/14

(52) U.S. Cl. CPC H01F 38/14
USPC 307/104

(57) ABSTRACT

A soft power wireless transmission induction plate includes a gap adjustment sheet, a shielding sheet and a separation sheet. The gap adjustment sheet includes a power induction module, an LED indication light and an LED indication light bar thereon. Through the power induction module, the present invention can supply power to an external electric appliance having induction coils in a wireless transmission way, achieving the object of wireless power supply. The present invention can decrease its entire thickness effectively to achieve an ultra-thin effect, and uses soft materials, without worrying about cracks and magnetic leakage. The LED indication light is to indicate the charging position and the LED indication light bar is to show the charging state.

### BACKGROUND OF THE INVENTION

1. Field of the Invention

The present invention relates to a power transmission device, and more particular to a soft power wireless transmission induction plate.

2. Description of the Prior Art

With improvement of technology, electric appliances become more and more important in our daily lives. Most of the electric appliances use electric wires for power transmission to the electric appliances. That is to say, the conventional way is to use a wired power supply device to supply power to an external electric appliance. However, the power supply way by using the wired power supply device for power transmission to the external electric appliance still needs to proceed with the connection of the wired power supply device for the user to use the electric appliance. It is inconvenient to use the electric appliance. The junction of the electric appliance and the wired power supply device may have a risk of electric leakage. Therefore, a power wireless transmission device is developed on the market, which uses electromagnetic induction for power transmission to solve the aforesaid problem.

A conventional power wireless transmission device comprises induction coils and an iron core plate. The induction coils are disposed on the surface of the iron core plate. An external electric appliance comprises a power induction module having induction coils for wireless power transmission. The power induction module approaches the induction coils of the power wireless transmission device. When the current flows to the induction coils of the power wireless transmission device, the iron core plate will generate a magnetic field. When the power induction module inducts the magnetic field, the induction coils of the power induction module will generate current for power transmission. However, the conventional power wireless transmission device doesn't have a magnetic field shielding structure. This may cause magnetic leakage when the power wireless transmission device transmits power by using electromagnetic induction. The power wireless transmission device may harm to health when in use. Furthermore, the iron core plate is fragile and has a certain thickness and is not flexible, so the power wireless transmission device takes up some space. When the power wireless transmission device drops or collides with other articles inadvertently, the iron core plate may crack and the iron core plate may separate from the induction coils to influence power induction. Accordingly, the inventor of the present invention has devoted himself based on his many years of practical experiences to solve these problems.

### SUMMARY OF THE INVENTION

The primary object of the present invention is to provide a soft power wireless transmission induction plate which decreases its entire thickness effectively to achieve an ultra-thin effect and uses soft materials, without worrying about cracks. There is no magnetic leakage to influence the work efficiency or other electric appliances or human body.

A further object of the present invention is to provide a soft power wireless transmission induction plate which can indicate the charging position and charging state.

In order to achieve the aforesaid objects, the soft power wireless transmission induction plate of the present invention comprises a power induction module. The power induction module comprises a plurality of induction coils, an LED indication light and an LED indication light bar. A gap adjustment sheet is provided under the power induction module. A shielding sheet is provided under the gap adjustment sheet for conducting magnetism. A separation sheet is provided under the shielding sheet. The separation sheet is flexible. Through the power induction module, the present invention can supply power to an external electric appliance having induction coils in a wireless transmission way, achieving the object of wireless power supply. The shielding sheet of the present invention can prevent electromagnetic interference and magnetic leakage, and the separation sheet is able to separate the magnetic field. The present invention doesn't have an iron core plate so it can decrease its entire thickness effectively to achieve an ultra-thin effect, without worrying about cracks. The LED indication light is to indicate the charging position and the LED indication light bar is to show the charging state.

### BRIEF DESCRIPTION OF THE DRAWINGS

FIG. 1 is a perspective view according to a first embodiment of the present invention;

FIG. 2 is an exploded view according to the first embodiment of the present invention;

FIG. 3 is a sectional view according to the first embodiment of the present invention;

FIG. 4 is a schematic view showing the use of the first embodiment of the present invention;

FIG. 5 is an exploded view according to a second embodiment of the present invention; and

FIG. 6 is a perspective view according to the second embodiment of the present invention.

### DETAILED DESCRIPTION OF THE PREFERRED EMBODIMENTS

Embodiments of the present invention will now be described, by way of example only, with reference to the accompanying drawings.

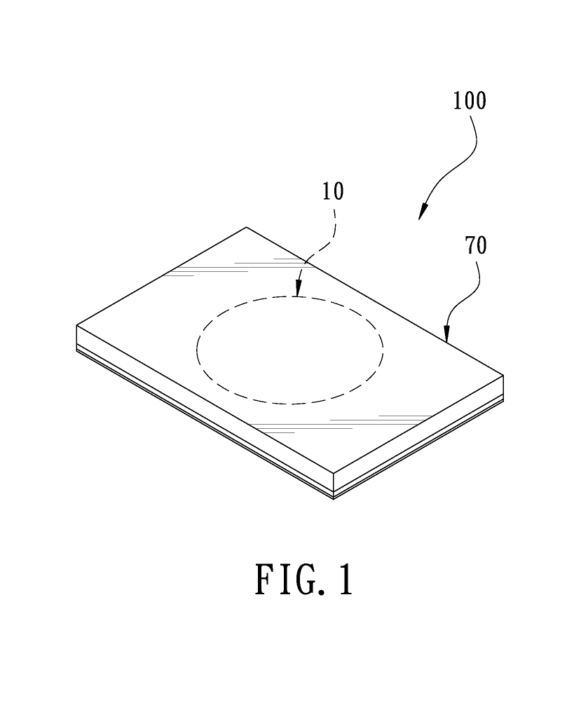

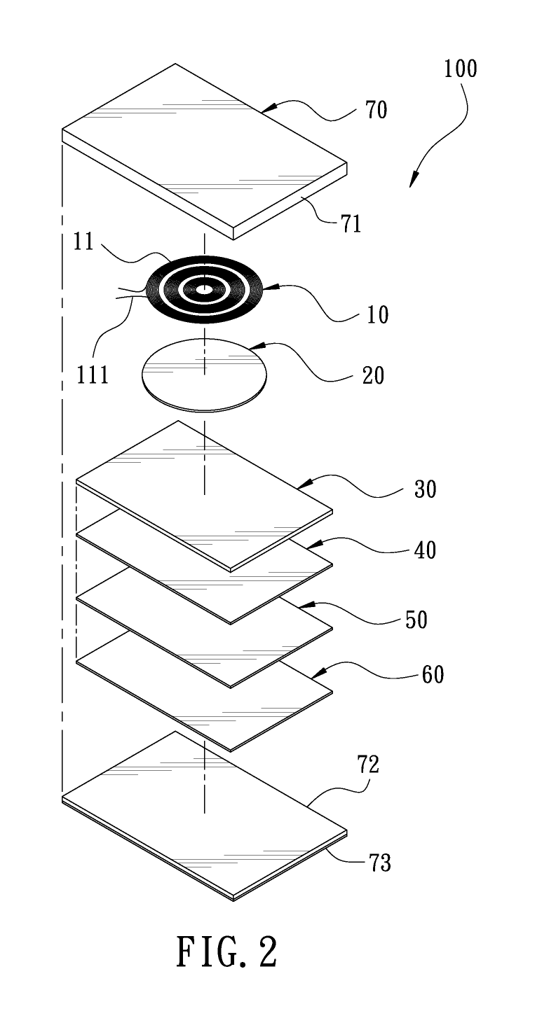

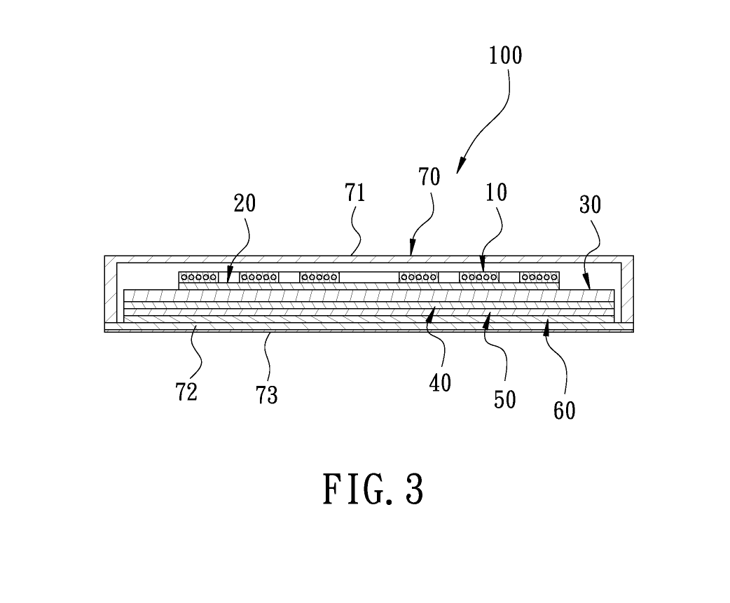

FIG. 1 is a perspective view according to a first embodiment of the present invention. FIG. 2 is an exploded view according to the first embodiment of the present invention. FIG. 3 is a sectional view according to the first embodiment of the present invention. The present invention discloses a soft power wireless transmission induction plate 100. The soft power wireless transmission induction plate 100 comprises a power induction module 10, a first adhesive layer 20, a gap adjustment sheet 30, a second adhesive layer 40, a shielding sheet 50, a separation sheet 60, and a casing 70.

The power induction module 10 is flexible. The power induction module 10 comprises a plurality of induction coils 11. The induction coils 11 are annular. The induction coils 11 are arranged and spaced in the form of concentric circles. The induction coils 11 have two conducting wires 11 for conducting current, such that the power induction module 10 is able to connect with external power.

The first adhesive layer 20 is disposed under the power induction module 10, and the power induction module 10 is attached to an upper surface of the first adhesive layer 20.

The gap adjustment sheet 30 is disposed under the first adhesive layer 20 and attached to a lower surface of the first adhesive layer 20. The gap adjustment sheet 30 is a flexible soft sheet. In the first embodiment of the present invention, the thickness of the gap adjustment sheet 30 is selective for adjusting the magnetic gap.

The second adhesive layer 40 is disposed under the gap adjustment sheet 30, and the gap adjustment sheet 30 is attached to an upper surface of the second adhesive layer 40. The area of the second adhesive layer 40 is substantially equal to that of the gap adjustment sheet 30.

The shielding sheet 50 is disposed under the second adhesive layer 40 and attached to a lower surface of the second adhesive layer 40. The area of the shielding sheet 50 is substantially equal to that of the second adhesive layer 40. In the first embodiment of the present invention, the shielding sheet 50 is a soft sheet made of iron powder glue for conducting magnetism and preventing electromagnetic interference and magnetic leakage.

The separation sheet 60 is disposed under the shielding sheet 50. The area of the separation sheet 60 is substantially equal to that of the shielding sheet 50. The separation sheet 60 has a plurality of through holes 61 around a circumferential portion thereof. In the first embodiment of the present invention, the separation sheet 60 is a soft sheet made of aluminum, and is able to separate the magnetic field, and functions as the base of the present invention.

The casing 70 comprises an upper cover 71 and a bottom board 72. The upper cover 71 is disposed on the bottom board 72. The casing 70 is to accommodate the power induction module 10, the first adhesive layer 20, the gap adjustment sheet 30, the second adhesive layer 40, and the shielding sheet 50 therein. The bottom of the bottom board 72 is provided with a skidproof rubber layer 73.

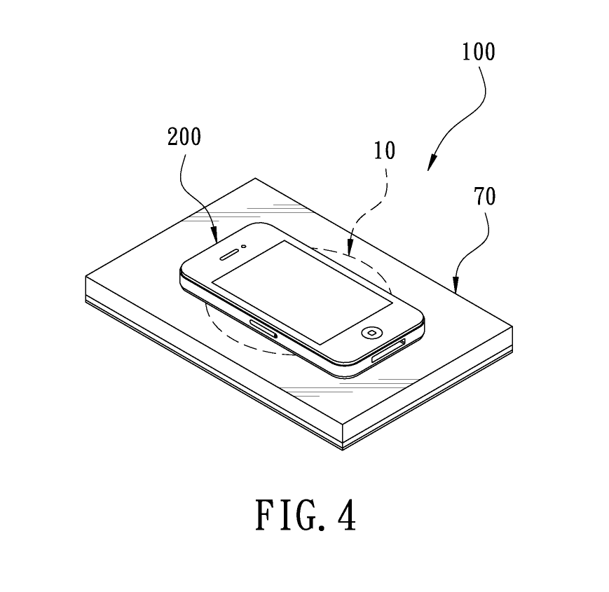

Referring to FIG. 4 and FIG. 1 to FIG. 3, the power induction module 10 of the present invention needs to connect with the external power to generate electricity. When an external electric appliance 200, such as a cell phone, needs an external power supply or needs to charge, the external electric appliance 200 is placed on the casing 70 and corresponds to the position of the power induction module 10. The soft power wireless transmission induction plate 100 can charge or supply power to the external electric appliance 200 in the way of electromagnetic induction through the induction coils 11 of the power induction module 10. This is convenient for use. It is noted that the power induction module 10 having the induction coils 11 of the present invention can charge or provide power to any external electric appliance with charging induction coils to enhance its use value.

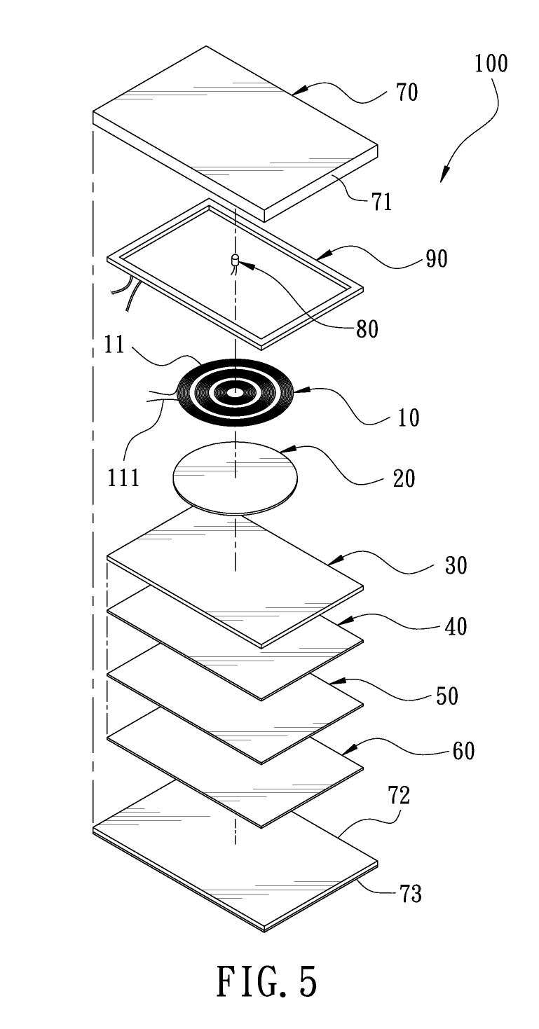

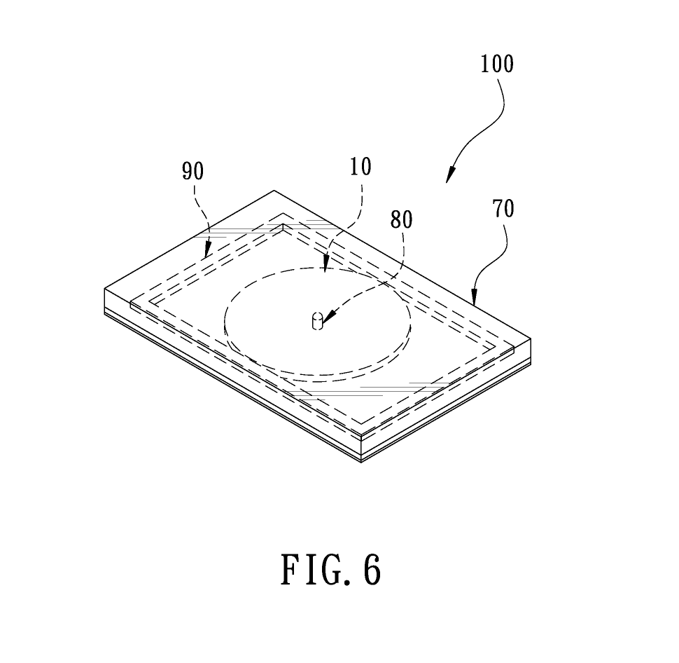

FIG. 5 is an exploded view according to a second embodiment of the present invention. FIG. 6 is a perspective view according to the second embodiment of the present invention. The second embodiment is substantially similar to the first embodiment with the exceptions described hereinafter. An LED indication light 80 is provided in the casing 70 and located at the center of the power induction module 10. The LED indication light 80 is electrically connected with the power induction module 10 as a mark of the power supply area so that the user can know the position of the power induction module 10. An LED indication light bar 90 is provided in the casing 70 and electrically connected with the power induction module 10. The LED indication light bar 90 has a rectangular shape and is located at the periphery of the power induction module 10. The LED indication light bar 90 is composed of light emitting diodes in different colors, such that the LED indication light bar 90 not only functions as the mark of the power supply area for the user to know the position of the power induction module 10 but also shows the power supply state of the soft power wireless transmission induction plate 100 by different illuminant colors. That is to say, the user can identify the charging state of the external electric appliance.

The features and anticipated effects of the present invention are described as follows:

1. All the gap adjustment sheet 30, the shielding sheet 50, the separation sheet 60 and the power induction module 10 of the present invention are made of flexible soft materials so that the present invention is flexible to be used conveniently.

2. The present invention comprises a power induction module 10. The power induction module 10 has induction coils 11 to supply power in the way of electromagnetic induction, so it can charge or supply power to an external electric appliance having induction coils in a wireless transmission way, achieving the object of wireless power supply.

3. The middle layer of the soft power wireless transmission induction plate 100 of the present invention is composed of a gap adjustment sheet 30, such that the soft power wireless transmission induction plate 100 can adjust the magnetic gap by selecting the gap adjustment sheet 30 in a different thickness.

4. The shielding sheet 50 of the soft power wireless transmission induction plate 100 can prevent electromagnetic interference and magnetic leakage, and the separation sheet 60 is able to separate the magnetic field. Because it uses soft materials, without worrying about cracks, there is no magnetic leakage to influence the work efficiency or other electric appliances or human body.

5. The soft power wireless transmission induction plate 100 of the present invention doesn't have an iron core plate. Compared to the conventional power wireless transmission device, the present invention can decrease its entire thickness effectively, achieving an ultra-thin effect.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A soft power wireless transmission induction plate, comprising:
a power induction module, the power induction module being flexible, the power induction module comprising a plurality of induction coils, the induction coils being annular, the induction coils being arranged and spaced in the form of concentric circles;
a gap adjustment sheet disposed under the power induction module; and
a shielding sheet disposed under the gap adjustment sheet for conducting magnetism and preventing electromagnetic interference and magnetic leakage.

2. The soft power wireless transmission induction plate as claimed in claim 1, further comprising a casing, the casing comprising an upper cover and a bottom board, the casing being to accommodate the power induction module, the gap adjustment sheet and the shielding sheet therein.

3. The soft power wireless transmission induction plate as claimed in claim 1, further comprising a first adhesive layer and a second adhesive layer, the first adhesive layer being disposed between the power induction module and the gap adjustment sheet, the power induction module being attached to an upper surface of the first adhesive layer, the gap adjustment sheet being attached to a lower surface of the first adhesive layer, the second adhesive layer being disposed under the gap adjustment sheet, the gap adjustment sheet being attached to an upper surface of the second adhesive layer, the shielding sheet being attached to a lower surface of the second adhesive layer, the area of the second adhesive layer being substantially equal to that of the gap adjustment sheet.

4. The soft power wireless transmission induction plate as claimed in claim 1, wherein the gap adjustment sheet is a flexible soft sheet, and the thickness of the gap adjustment sheet is selective for adjusting a magnetic gap.

5. The soft power wireless transmission induction plate as claimed in claim 1, wherein the shielding sheet is a soft sheet made of iron powder glue.

6. The soft power wireless transmission induction plate as claimed in claim 1, wherein the separation sheet is a soft sheet made of aluminum.

7. The soft power wireless transmission induction plate as claimed in claim 2, further comprising an LED (light emitting diode) indication light, the LED indication light being located at the center of the power induction module.

8. The soft power wireless transmission induction plate as claimed in claim 2, further comprising an LED indication light bar, the LED indication light bar having a rectangular shape and being located at the periphery of the power induction module.
